(19) United States
(12) Patent Application Publication
(10) Pub. No.: US 2021/0068412 A1
(43) Pub. Date: Mar. 11, 2021

(54) METHOD FOR PRE-COOKING RICE FOR THE FINAL COOKING THEREOF IN A MICROWAVE IN EIGHT MINUTES

(71) Applicant: PAELLASUR S.L, Córdoba (ES)

(72) Inventor: FRANCISCO ZAMORA PEREZ, Córdoba (ES)

(73) Assignee: PAELLASUR S.L, Córdoba (ES)

(21) Appl. No.: 16/643,391

(22) PCT Filed: Aug. 30, 2018
(86) PCT No.: PCT/ES2018/000066

§ 371 Date: Feb. 28, 2020

(30) Foreign Application Priority Data
Sep. 1, 2017 (ES) P201700714

(51) Int. Cl. A23B 9/02; A23B 9/10; A23L 3/36; A23L 7/196

(52) U.S. Cl. CPC A23B 9/02; A23L 7/1965; A23L 3/36; A23B 9/10

(57) ABSTRACT

Process of the product obtained from raw rice mixed with ingredients such as extra virgin olive oil, vegetables, seafood, fish and meat, which establishes a cooking method for obtaining a pre-cooked, which is characterized by its quick and easy finish for the consumer, which consist in its cooking in a microwave in 8 minutes.

### FIELD OF TECHNOLOGY

The invention of the “process of a pre-cooked rice for its final cooking in a microwave in 8 minutes” is part of the industrial manufacture of pre-cooked food and distribution to large supermarket chains and the hotel and catering sector.

### BACKGROUND TO THE INVENTION

Currently, the field of precooked rice dishes is taking on a lot of importance, as paella is the most popular recipe in Spanish gastronomy at an international level. The difficulty and cost involved in cooking an individual rice preparation means that companies develop processes such as those already in place. Some are based on supplying a can of processed and pasteurized broth with the corresponding amount of raw rice, this if found in supermarkets and large surfaces. There is also a product used mainly in the hotel and catering sector of a mixture of boiled rice with ultra-frozen raw ingredients (seafood etc . . . ) to which you add water and finish cooking in the traditional way.

Others mix stir fry and raw rice with raw ingredients (seafood etc . . . ) deep-frozen to which you add water and finish it off in the traditional way.

In the patent document ES2354668B1 it is proposed a procedure of a broth with the stir fry to add the final consumer rice or noodles and its later cooking. It would therefore be ideal to make a precooked rice preparation which includes all the ingredients already cooked in the absence of the recommended water for the complete cooking of the product, in a microwaveable container for an easy and quick preparation in a microwave in only 8 minutes.

To this end, the present invention focuses on the mixing of all the ingredients, cooked and dehydrated at a specific temperature and time, so that the end consumer can finish their complete cooking.

### EXPLANATION OF THE INVENTION

The present invention refers to a new pre-cooked dish for human consumption based on rice and stir fry with various ingredients such as seafood, fish, vegetables, meat and without limiting other ingredients. To its process of obtaining and packaging in a suitable container, to be able to carry out its final cooking in a microwave in a short period of time, specifically 8 minutes.

This invention makes this new pre-cooked food can be in any refrigerator or freezer, domestic or professional, anywhere in the world ready for an easy and fast completion of your cooking in a microwave. This process will ensure that the starch does not come off in the final cooking, you only have to add the water indicated on the label, which is 325 mi of water for every 110 gr of rice. The recommended microwave power is 800 W-900 W.

Giving solution to the complexity that for a great majority of people supposes to add the correct amount of water and salt to leave a rice in its correct cooking point without being overwhelmed and the most important thing the comfort and saving in time that supposes this new invention.

### REALIZATION OF THE INVENTION

The present invention can be developed in different types of containers suitable for cooking by fire or electric heat sources. It is advisable to use polished steel paella. Example of ingredients for a portion.
1 0 g boneless chicken
50 grams of green beans
4 g of garlic
30 g of onion
0.5 g sweet paprika
40 gr of tomato
110 g of raw rice
1 g of food colouring
2 gr of salt
5 grams of dehydrated chicken broth

Pour extra virgin olive oil into a paella pan over medium heat and fry according to variety, meat, fish, seafood or vegetables. When they are golden brown, remove them to cool and set aside. Then, washed and cut, we add garlic, onions, peppers and tomatoes for frying. When we have the golden fried and well dehydrated we add the raw rice, food coloring, salt and dehydrated broth according to variety. The technique of mixing and dehydration is applied, which consists of continuously moving, turning and scratching the bottom of the container for 12 to 15 minutes so that no ingredient is burned. The tools to be used in this teak are steel spatulas and preferably two, one in each hand, at each moment we will scrape the steel spatulas together so as not to allow material (obtained from the bottom of the container) to accumulate on the tips of the steel spatulas, the chip from the scraping will be deposited in the mixture of all the ingredients. We will be 12 to 15 minutes executing this procedure until it exceeds 85° C., the fire power will be medium-low. Once the process is finished, we cool the mixture to proceed with the packaging in containers suitable for microwaves, adding, according to the variety, the product previously fried in case of meat, seafood, fish or vegetables and we thermoseal it in a vacuum and with a protective atmosphere. For preservation we refrigerate it from 0° C. to 4° C. or from −18° C. to −25° C.

### INDUSTRY APPLICATION

The invention of the “process of a pre-cooked rice for final cooking in a microwave in 8 minutes” is aimed at the industrial manufacture of pre-cooked food and distribution to large national and international supermarket chains. The ease of use of this pre-cooked rice makes it a novelty, and anyone who can handle a microwave can enjoy freshly cooked rice in its many varieties. The recommended microwave power is 800 W-900 W.

Giving solution to the complexity that for a great majority of people supposes to add the correct amount of water and salt to leave a rice in its correct cooking point without moving it and without being overwhelmed and most important the comfort and time saving that supposes this new invention.

1. (canceled)

2. A method for preparing a pre-cooked rice for final cooking in a microwave in eight (8) minutes, the method comprising:
stir-frying raw rice and one or more ingredients selected from the group consisting of extra virgin olive oil, vegetables, seafood, fish, meat, dyes salt, dehydrated broth and spices over a fire power of medium-low heat, the stir-frying comprises:
mixing the raw rice and the one or more ingredients selected from the group consisting of extra virgin olive oil, vegetables, seafood, fish, meat, dyes salt, dehydrated broth and spices for twelve (12) to fifteen minutes (15) until the temperature of the raw rice and one or more ingredients reaches eighty-five (85) degrees Celsius;
cooling the stir-fry of the raw rice and the one or more ingredients selected from the group consisting of extra virgin olive oil, vegetables, seafood, fish, meat, dyes salt, dehydrated broth and spices heated to eighty-five (85) degrees Celsius;
vacuum sealing the cooled stir-fry; and
refrigerating the vacuum sealed stir-fry at a temperature selected from one of the ranges consisting of zero (0) degrees Celsius to four (4) degrees Celsius and minus eighteen (18) degrees Celsius to minus twenty-five (25) degrees Celsius.
